(19) United States
(12) Patent Application Publication
(10) Pub. No.: US 2010/0201084 A1
(43) Pub. Date: Aug. 12, 2010

(54) Clamping Apparatus and Arrangement of Such a Clamping Apparatus with a Collet

(75) Inventor: Attilio Mandarello, Affalterbach (DE)

Correspondence Address: AKERMAN SENTERFITT, P.O. BOX 3188, WEST PALM BEACH, FL, 33402-3188, US

(73) Assignee: Hainbuch GmbH Spannende Technik, Marbach (DE)

(21) Appl. No.: 12/701,247

(22) Filed: Feb. 5, 2010

Related U.S. Application Data
(63) Continuation of application No. PCT/EP2008/006340, filed on Aug. 1, 2008.

(30) Foreign Application Priority Data
Aug. 7, 2007 (DE) DE 102007038789.1

(51) Int. Cl. B23B 31/20

(52) U.S. Cl. 279/51

(57) ABSTRACT

A chuck for accommodating a multipart collet for clamping a workpiece in place has a housing with a collet receptacle having a guide device and guide surfaces. The collet is movable on the chuck in the axial direction. The guide device has balls as rolling elements on the guide surfaces, of which a multiplicity are continuously arranged on a rolling element holder. They are movable together with the latter in the guide device from an initial position into the chuck. A restoring device is provided for the rolling element holder, with a direction of action out of the chuck, in order to move the balls back into the initial position when no collet is in the chuck.

### FIELD OF APPLICATION AND Prior Art

The invention relates to a clamping apparatus according to the preamble of claim 1 and to an arrangement of such a clamping apparatus with a collet.

Such a clamping apparatus is known, for example, from US 2007 210537 A1. In this publication, rolling elements are provided in order to reduce the friction between the collet or the segments thereof in a multipart collet and the guide surfaces of the clamping apparatus. The rolling elements are in this case designed as rollers.

A disadvantage with this is that the rollers in this type of guide can tilt and then jam or the rolling mounting no longer functions correctly. Furthermore, a situation may arise in which the rolling elements remain in a position relatively deep within the chuck after removal of a collet and are then located, after renewed insertion of a collet, on a bottom or inner stop and can no longer roll. This is also very disadvantageous for the guide or friction on the guide.

### PROBLEM AND SOLUTION

The problem addressed by the invention is to provide a clamping apparatus of the type mentioned at the beginning and an arrangement with which problems of the prior art can be solved and in particular an improved construction of the guide device can be achieved, with functioning always ensured.

This problem is solved by a clamping apparatus having the features of claim 1 and by an arrangement having the features of claim 16. Advantageous and preferred configurations are the subject matter of further claims and are explained in more detail below. The wording of the claims is made part of the content of the description by express reference.

The clamping apparatus is designed for accommodating a multipart collet and to this end has a housing and a collet receptacle assigned to the housing. The collet has a guide device and guide surfaces, on which the collet or the segments thereof is/are accommodated for clamping a workpiece in place and is/are movably guided in a direction into the clamping apparatus. As described, the guide device has rolling elements on these guide surfaces for reducing the friction during a movement of the collet in the collet receptacle. In this case, a plurality of rolling elements are jointly and continuously arranged on a rolling element holder and are movably mounted or arranged together with the latter in the guide device. The mobility is provided from an initial position, in which the rolling elements are at a maximum distance from the interior of the clamping apparatus and are located in particular toward a front end of the clamping apparatus, into the clamping apparatus, that is to say away from the front end of the clamping apparatus and into it. According to the invention, a restoring device is provided for the at least one rolling element holder. This restoring device acts in a direction out of the clamping apparatus or in a direction of movement of the rolling elements along the guide surfaces in such a way that the rolling elements are moved back into the initial position. In particular, the restoring device brings the rolling elements into the aforesaid initial position when no collet is put into the clamping apparatus or is in contact with the guide surfaces or rolling elements.

According to the invention, it is therefore ensured that the rolling elements are always brought back into the initial position when no collet is inserted into the clamping apparatus. The rolling elements are therefore always in an optimum position for the insertion of the collet, namely the correspondingly defined initial position, and can ensure, from this position, optimum guidance of the collet in the collet receptacle together with guide device.

According to an advantageous configuration of the invention, the rolling elements are balls. This has the advantage of ease of manufacture and good availability. Furthermore, although balls have the disadvantage of point mounting or point contact compared with rollers or cylinders, they are at the same time secured against tilting and can support and guide a movement in any desired direction per se.

Irrespective of the design of the rolling elements, a rolling element holder can be designed in such a way that it is planar and elastically holds or has a plurality or a multiplicity of rolling elements over its surface. The rolling element holder is advantageously made of an elastic solid material, in particular rubber or a rubber-like material. The rolling elements are embedded therein; in particular, they are encapsulated therein, that is to say they are formed and produced integrally or as a construction unit with the rolling element holder. At the same time, the rolling elements advantageously project beyond both surfaces of the rolling element holder in order to bear against the guide surfaces of the clamping apparatus and against the collet, respectively. This projection of the rolling elements beyond the holder may amount to several percent of the diameter thereof. In an especially advantageous manner, the rolling element holder is designed as a mat with the rolling elements therein, as known, for example, from DE 102 342 10 A1, the content of which in this respect is made part of the content of the present description by express reference.

Such a planar, mat-like rolling element holder may have, at least on one side, circumferential and elastically designed sealing lips or sealing beads or the like at the outer margin thereof. If these seals bear against the mating surface of the rolling elements, the ingress of dirt, which could permanently damage the guide or the clamping apparatus, can be prevented. It is considered to be advantageous to provide such seals at least on the side toward the collet and possibly also on the other side toward the guide surfaces. The projection of the sealing lips or the like beyond the rolling elements may in turn be a few percent, for example up to 10%, of the thickness of the rolling element holder.

There are different basic possible ways of designing the restoring device according to the invention. According to a first basic design, the restoring device is designed in such a way that it is activated, as it were, automatically or independently or activates itself in such a way. Provided for this purpose, for example, is an elastic spring which is simply preloaded or, in the case of a compression spring, compressed when a collet is inserted into the clamping apparatus and the rolling elements are subsequently moved along the guide surface of the guide device and along the segments of the collet and during the movement, resulting therefrom, of the rolling element holder. The requisite force should not be too large since it otherwise adversely affects the ease of motion of the guide device. On the other hand, the spring force should be large enough to ensure without fail that the rolling element holder and with it the rolling elements are moved back into the aforesaid initial position when the collet is removed from the clamping apparatus. Such a restoring device is considered to be automatic or independent since no further engagement, whether as a separate step or by double function of a movement, is necessary.

There are several possible ways of designing a spring referred to. On the one hand, such springs may be formed as spiral springs or leaf springs, in particular from metal. On the other hand, a spring may be formed in a block-like manner with a spring body, for example from elastic or rubber-like material. Such a spring body is advantageously compressed during a movement of the rolling elements out of the initial position and can then push the rolling elements back into the initial position by means of the stored pressure force. Such a spring body can be retained between a rolling element holder and an inner stop on the clamping apparatus. This inner stop may either be provided in any case or else may be provided specifically for the springs. In a further configuration of the invention, a spring may be fastened directly to the rolling element holder or may be formed thereon, in particular in a captive manner as a construction unit. In a design of the rolling element holder as an elastomeric mat, a solid material section or a partial section of the rolling element holder may form the spring. Such a spring body may also be made of a different material and be fastened to the rolling element holder, for example adhesively bonded thereon. Therefore both loss of the spring is avoided and simple assembly is ensured, and the association between rolling element holder and spring cannot vary. Thus the spring action achieved will always be the same.

In an alternative basic design of the invention, the restoring device may be designed in such a way that it is activated by external actuation or is externally actuated. In this case, it is normally designed without an aforesaid spring or the like. Here, it is designed, for example, in such a way that it can be actuated by an “inner draw tube” provided for drawing the collet into the clamping apparatus. The inner draw tube, when the collet is released in a direction out of the clamping apparatus, likewise moves at least partly in this direction and therefore moves the rolling element holder in this direction and thus back into the initial position. In this case, the restoring device is therefore actuated by said inner draw tube or the inner draw tube is part of the restoring device.

To make it easier to adapt a clamping apparatus according to the invention or a chuck according to the invention to existing machines which have an inner draw tube referred to, and as a rule the inner draw tube is not designed in such a way that it does not bear against the rolling element holders on its own, provision may be made in a configuration of the invention for adapters or intermediate pieces to be provided, to which pressure is applied by the inner draw tube, and which in turn transmit this pressure to the rolling element holder and thus move it into the initial position. During movement in the opposite direction, that is to say when a collet is inserted, the intermediate pieces are moved by the rolling element holder, advantageously in a synchronous movement together with the inner draw tube, which finally draws the collet into the clamping apparatus.

In the case of such externally actuated restoring, the application of force to the rolling element holder by the inner draw tube, in particular also with intermediate pieces, is advantageously effected merely via pressure.

In a configuration of the invention, rolling elements with rolling element holders are provided on all the guide surfaces of the clamping apparatus. In particular, the rolling element holders are of identical design, which limits the cost.

The rolling element holders may be mounted in holder guides or the like or in the guide devices on the guide surfaces in such a way that they can be moved only along one axis or in one direction. To this end, grooves may be provided on the guide devices, in which grooves a rolling element holder can engage with lateral regions, for example flattened, projecting regions at the sides. Such a guide device enables a movement of the rolling element holders and thus also of the rolling elements to be predetermined more accurately for better guidance properties. Furthermore, for example in conjunction with the aforesaid seals, the ingress of dirt between the rolling elements and the guide surfaces on the clamping apparatus can also be reduced, if necessary also toward the collet. In addition, this can also prevent the rolling element holders from falling out of the clamping apparatus if they are not directly pressed in place by a collet.

To improve a guide, a guide surface on the chuck, with which guide surface the rolling elements are in contact, may be made of carbide, in particular in the case of balls as rolling elements. This may be either a coating or else an inserted carbide plate. Alternatively, entire inserts, for example like pockets, for the guide may be made of carbide.

It has been found within the scope of the invention that, when a multiplicity of balls are used as rolling elements, it is very advantageous if a plurality of balls are arranged in respective rows, in particular in a regular arrangement. These rows enclose an angle of between 5° and 15° with a direction of movement of the collet segments, or with a plane through the center longitudinal axis of the clamping apparatus, when a collet is inserted. Thus the fact that balls as rolling elements run in a slightly deviating manner from said direction of movement or slightly obliquely thereto can be taken into account, as has been found during development work within the scope of the invention. In the case of a polygonal collet receptacle and correspondingly designed collets, this is due to the slight lateral offset resulting therefrom during the drawing-in, which will be described in more detail below with reference to the figures.

The balls can then advantageously run on one of the two sides in channels designed precisely in accordance with this slightly oblique direction, in which case these channels may have a depth of about 5% to 30% of the diameter of the balls and correspond exactly to the external shape of the balls or to the radius thereof. Thus the guide is improved somewhat in comparison with pure point mounting, since the balls are in contact at their outer circumference with the guide surfaces, at least over a certain width. For example, 6 to 15 parallel rows of balls as rolling elements may be provided for each guide surface. In a normally simpler configuration, such channels are provided on the collets. Therefore carbide can be dispensed with here. The guide surfaces of the clamping apparatus itself may have, as described above, carbide facings, which would be more difficult on a collet made of otherwise standard tool steel.

Furthermore, the invention also relates to an arrangement of a clamping apparatus described above, with its different, possible features, with a collet likewise described above, as is also disclosed, for example, by US 2007 210537 A1, to which reference is expressly made.

These and further features can be gathered from the description and the drawings, as well as from the claims, and the individual features can be realized on their own, or a plurality thereof can be realized in subcombinations, in an embodiment of the invention and in other fields and can constitute advantageous and independently protectable embodiments, for which protection is claimed here. The subdivision of the application into individual sections and subheadings do not restrict the general validity of the statements made thereunder.

### BRIEF DESCRIPTION OF THE DRAWINGS

Exemplary embodiments of the invention are schematically shown in the drawings and are explained in more detail below. In the drawings:

FIG. 1 shows an oblique view of a partial section through a clamping apparatus according to the invention, with balls on a guide device,

FIG. 2 shows the clamping apparatus from FIG. 1 with a segment of an inserted collet,

FIG. 3 shows the plan view of a plane of section through FIG. 2,

FIG. 4 shows an oblique illustration of a mat-like rolling element holder from FIG. 1, and

FIG. 5 shows a section through the rolling element holder from FIG. 4.

### DETAILED DESCRIPTION OF THE EXEMPLARY EMBODIMENTS

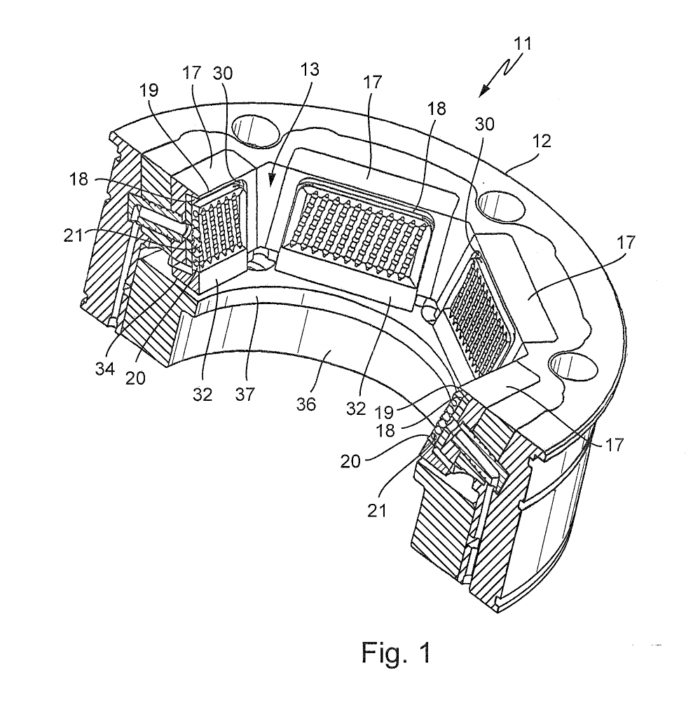

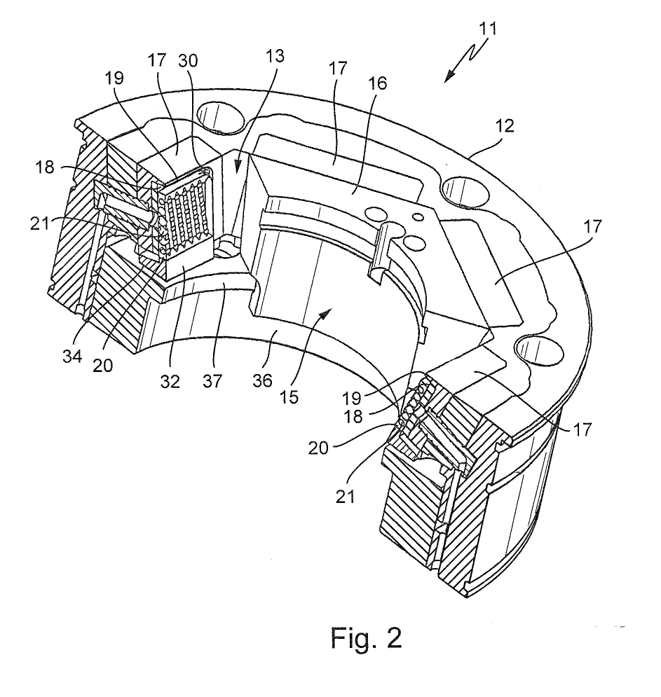

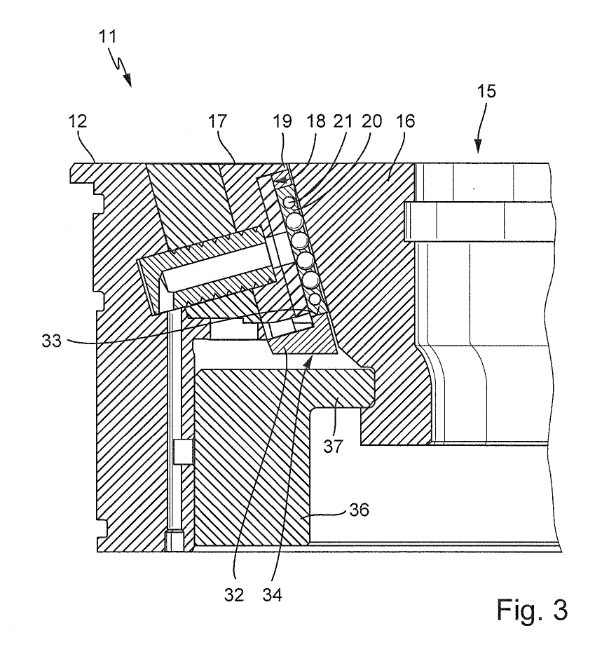

Shown in FIGS. 1 to 3 is a clamping apparatus 11 which is designed like a chuck. It has a housing 12 which forms, with a central opening, a collet receptacle 13. As can be seen from FIG. 2, a collet 15, of which one of three segments 16 is depicted, which are elastically connected to one another, can be used as an arrangement according to the invention. Such collets as well as such clamping apparatuses are disclosed, for example, by US 2007 210537 A1. Instead of a polygonal collet 15 or collet receptacle 13, a round collet receptacle for round collets could also be provided.

The collet receptacle 13 has six guide devices 17, with projections formed as top sides, matching the hexagonal collet 15, which is only partly shown. Each guide device 17 has a planar guide surface 18, which belongs, as it were, to the clamping apparatus 11. A respective rolling element holder 20, which has balls 21 as rolling elements, is in contact with each guide surface 18. In this case, all the balls 21 are in contact with the guide surfaces 18.

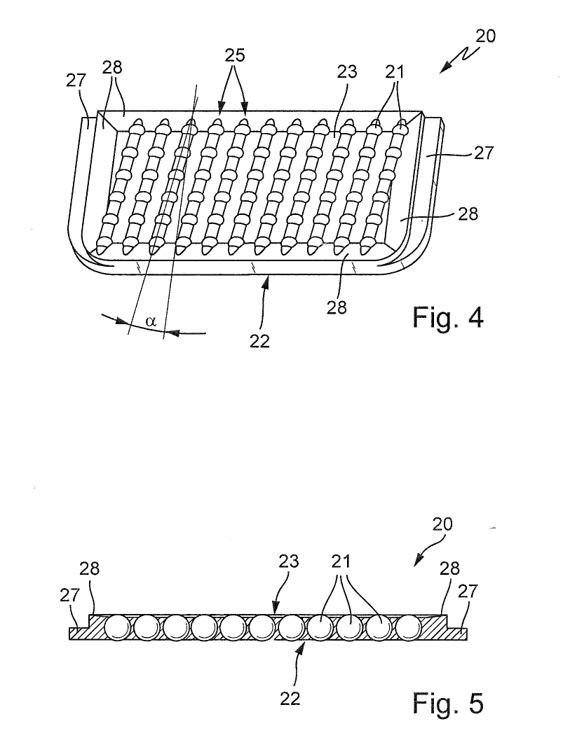

The mat-like rolling element holder is to be explained briefly with reference to FIGS. 4 and 5. It has a body made of rubber-like material, in particular natural rubber, in which the balls 21 are encapsulated. As can be seen in particular from the section in FIG. 5, the balls 21 project slightly beyond an underside 22 and a top side 23, for example with about 5% to 10% of the diameter thereof. This ensures that, when the outer side of the segments 16 of the collet 15 is in contact, the balls 21 form the mounting.

It can be seen that the balls 21 are arranged in rows 25 of six balls each, to be precise eleven of such rows 25. It can also be seen that the rows are oblique or are at an angle α to a plane which passes through a center longitudinal axis of the clamping apparatus 11. This will be explained in more detail later.

The rolling element holder 20 has narrower guide regions 27 at the two side margins. Said guide regions 27 are approximately half as thick as the rest of the rolling element holder 20. Furthermore, the top side 23 or the balls 21 are surrounded by an integrally formed sealing lip 28. The latter projects beyond the balls 21 and causes a planar surface, against which the rolling element holder 20 bears, for example on the outer side of the segments 16, to press against the sealing lips 28, and the latter, even when the balls are also in contact with this surface, therefore shield the region in which the balls are in contact to the outside. Thus no dirt can get between the outer side of the segments 16 of the collet 15 and the balls 21 when the latter are in contact. The guide regions 27 in undercuts 30 of the guide devices form a similar dirt barrier.

Even though in FIG. 5 the sealing lips 28 are provided only on the top side 23 of the rolling element holder 20, it is perfectly possible to also provide them on the underside 22. To realize such rolling element holders 20 or with regard to the encapsulation of the balls 21 with the rubber, reference is made, for example, to aforementioned DE 102 342 10 A1, which in this respect is made part of the content of this description by express reference.

As can be seen from FIGS. 1 and 2, each of the guide devices 17 or guide surfaces 18 has a respectively identical rolling element holder 20. In this case, the guide devices 17 have undercuts 30 on both sides, in which the guide regions 27 of the rolling element holders 20 run. It can be seen that the rolling element holders 20 can be moved with slight lateral play in the guide devices 17 substantially only parallel to a center longitudinal axis of the clamping apparatus 11. This lateral play will be discussed in more detail below.

A respective stop 32 is provided below each rolling element holder 20. It has a stop edge 33 and a bottom stop surface 34. The width of the stop edge 33 corresponds approximately to the thickness of the rolling element holder 20 and bears against the underside thereof. At its ends, the stop 32 is mounted on the housing 12 in such a way that it can be moved solely in the direction of the undercuts 30.

The clamping apparatus 11 has an inner draw tube 36 having a projection 37 pointing toward the center longitudinal axis. Said projection 37 engages in a known manner behind corresponding grooves in the bottom region of the segment 16 for drawing the collet 15 into the clamping apparatus 11. In the illustrations of FIGS. 1 to 3, the collet 15 has already been drawn ready for use into the clamping apparatus 11 by means of the inner draw tube 36. Therefore the rolling element holders 20 are moved inward a short distance from their initial position into the guide devices 17, such that there is a gap between their top edges and the top sides 19 of the guide device 17. This is because the rolling element holders 20 would strike these top sides 19 in the initial position.

Since the inner draw tube 36 is moved into the clamping apparatus 11 when the collet 15 is drawn in, the stop 32 also has sufficient space to be likewise moved into the clamping apparatus 11 and to provide clearance of motion for the rolling element holders 20. This is because the latter, due to the contact of the outer surfaces of the segments 16, are moved along the guide surfaces 18 likewise into the clamping apparatus 11, although of course they cover only half the distance as the segments 16 themselves.

The type of mounting of such a collet 15, consisting of a plurality of segments, in a chuck described is known to the person skilled in the art. If the inner draw tube 36 is moved out of the clamping apparatus 11 again in order to remove the collet 15, the segments 16 slide with very low friction along the guide surfaces 18 by means of the balls 21. In the process, the segments of the collet 15 widen relative to one another and a workpiece clamped in place between them beforehand is released. At the same time, after a short displacement, the top side of the inner draw tube 36 comes to bear against the bottom stop surfaces 34 of the stops 32 and presses, via the top stop edge 33, the rolling element holders 20 outward in the guide device 17 and thus back into the initial position, approximately up to the projecting top side 19. If the collet 15 is then removed, which is not possible until after the inner draw tube 36 has moved to the end position, the rolling element holders 20 are already in the initial position again and are ready to ensure again from the beginning that guidance is as effective as possible when another collet is inserted.

It can also be seen that, when the collet 15 is released by movement of the inner draw tube 36 in a direction out of the clamping apparatus 11, the stops 32 and thus also the rolling element holders 20 are automatically moved in this direction out of the clamping apparatus. Therefore no further activities or movements are necessary.

To improve the mounting or guidance, the guide surfaces 18 may have carbide facings, for example by means of the aforesaid inserted carbide plates. Channels can be made, for example milled, in the outer sides of the segments 16, the shape of said channels corresponding exactly to the shape or the diameter of the balls 21. The channels should run at the same angle α as the rows 25 according to FIG. 4, so that these channels lie exactly over the rows 25 of balls 21, or the balls run therein. In this respect, it is also obvious why the lateral play of the rolling element bodies 20 in the guide devices 17 is necessary, since, during such a slightly oblique movement of the balls 21, a slight component of movement is also to be transmitted to the undercuts 30, and this is absorbed by the lateral play.

In a modification of the invention, it can easily be imagined how solid spring bodies or spring blocks made of elastic material, for example likewise rubber, could be provided instead of the stops 32 shown. Said spring bodies or spring blocks could be fixed to the undersides or at the bottom, such that the rolling element holders 20 press against these springs when moving into the clamping apparatus 11 when the collet is drawn into the clamping apparatus. If the collet is released or moved out again, the compressed spring bodies can move the rolling element holders back again and into the initial position.

In yet another configuration, it can also be imagined that such spring bodies are fastened, for example adhesively bonded, to the bottom edges of the rolling element holders 20 or are designed as projecting regions. Their inherent elasticity then produces the spring force.

1. A clamping apparatus like a chuck or the like, for accommodating a multipart collet for clamping a workpiece in place, said clamping apparatus comprising a housing and a collet receptacle assigned to said housing, said collet receptacle having a guide device and guide surfaces, on which said collet is movably guided in an axial direction of said clamping apparatus, said guide device having rolling elements on said guide surfaces, wherein a plurality of rolling elements is jointly and continuously arranged on a rolling element holder and is movable together with said rolling element holder in said guide device from an initial position, in which said rolling elements are at a maximum distance from an interior of said clamping apparatus, into said clamping apparatus, wherein a restoring device is provided for said rolling element holder, with a direction of action out of said clamping apparatus in a direction of movement of said rolling elements along said guide surfaces, in order to move said rolling elements into said initial position when no collet is in contact with said guide surfaces or said rolling elements.

2. The clamping apparatus as claimed in claim 1, wherein said rolling elements are balls.

3. The clamping apparatus as claimed in claim 1, wherein said rolling element holder is made of an elastic solid material and formed like a mat, and wherein said rolling elements are embedded therein and are projecting slightly beyond two flat sides of said rolling element holder.

4. The clamping apparatus as claimed in claim 1, wherein said rolling element holder is formed planar or mat-like and is provided at an outer margin with circumferential, elastic sealing lips projecting slightly beyond said rolling elements at least on a side toward said collet.

5. The clamping apparatus as claimed in claim 1, wherein said restoring device is activated automatically with an elastic spring, which is preloaded or compressed when said collet is inserted and said rolling elements are subsequently moved along said guide surface of said guide device into said clamping apparatus and relaxes and moves back and moves said rolling elements together with said rolling element holder into said initial position when said collet is removed.

6. The clamping apparatus as claimed in claim 5, wherein said spring is formed in a block-like manner and is retained between said rolling element holder and an inner stop on said clamping apparatus.

7. The clamping apparatus as claimed in claim 6, wherein said spring is a spring block, which is fastened to said rolling element holder in a fixed manner.

8. The clamping apparatus as claimed in claim 6, wherein said spring is formed from rubber-like material.

9. The clamping apparatus as claimed in claim 1, wherein said restoring device is externally actuated or is force-actuated, wherein it can be actuated by an inner draw tube provided for drawing said collet into said clamping apparatus, wherein said inner draw tube, when said collet is released, moves in a direction out of said clamping apparatus and bears with stops against said rolling element holder for moving it into said initial position, wherein an application of force to said rolling element holder by stops of said inner draw tube is designed in such a way that only a pressure force is transmitted.

10. The clamping apparatus as claimed in claim 1, wherein said rolling elements with said rolling element holders are provided on all said guide surfaces.

11. The clamping apparatus as claimed in claim 10, wherein said rolling element holders are mounted in said guide devices on said guide surfaces in such a way that they are movable only along one axis or in one direction.

12. The clamping apparatus as claimed in claim 11, wherein said guide devices have grooves or undercuts, in which projecting regions of said rolling element holder engage for guidance.

13. The clamping apparatus as claimed in claim 1, wherein a guide surface on said clamping apparatus, with which guide surface said rolling elements are in contact, has a carbide facing or an integrated carbide plate.

14. The clamping apparatus as claimed in claim 1, wherein a multiplicity of balls are arranged as said rolling elements in said rolling element holder and a plurality of said balls form respective rows in a regular arrangement, at an angle of between 5° and 15° to said direction of movement of said rolling element holder when said collet is inserted into said clamping apparatus.

15. The clamping apparatus as claimed in claim 14, wherein channels having a radius of said balls are provided on an outer surface of said collet, with which surface said balls are in contact, and said channels are at the same angle to said direction of movement of said rolling element holder as said rows of said balls of said rolling element holder.

16. An arrangement of a clamping apparatus as claimed in claim 1 with a collet.
